(19) United States
(12) Patent Application Publication
(10) Pub. No.: US 2026/0010142 A1
(43) Pub. Date: Jan. 8, 2026

(54) Autonomous Process Recipe Generation for Semiconductor Process Systems through Reinforcement Learning

(71) Applicant: Yang Pan, SINGAPORE (SG)

(72) Inventor: Yang Pan, SINGAPORE (SG)

(73) Assignee: Inspiring Atoms Pte Ltd, SINGAPORE (SG)

(21) Appl. No.: 18/765,253

(22) Filed: Jul. 6, 2024

(51) Int. Cl. G05B 19/4099

(52) U.S. Cl. CPC G05B 19/4099; G05B 2219/45031

(57) ABSTRACT

Disclosed herein are systems and methods for autonomously generating semiconductor process recipes using reinforcement learning (RL) based on digital twins. By employing a neural network version of the digital twin, the system enhances computing efficiency, allowing exploration of large parameter spaces. An RL agent, guided by a policy neural network and a Monte Carlo tree search (MCTS) program, autonomously generates many learning cases, calculates associated rewards, and continuously improves the policy neural network.

### FIELD OF THE INVENTION

The present invention relates to semiconductor manufacturing processes, specifically to systems and methods for autonomously generating process recipes in semiconductor fabrication. This invention employs reinforcement learning (RL) algorithms and digital twins to generate process recipes for various semiconductor process systems, including but not limited to reactive ion etching (RIE), atomic layer etching (ALE), plasma-enhanced chemical vapor deposition (PECVD), and atomic layer deposition (ALD). The inventive concepts aim to enhance precision, efficiency, and automation in the development of semiconductor process recipes.

### BACKGROUND

The semiconductor industry is constantly striving to improve the precision and efficiency of various etching and deposition processes, which are essential for fabricating integrated circuits and other semiconductor devices. Achieving precise control over material removal and deposition at the atomic level is crucial for developing nanoscale structures. However, optimizing these processes to meet specific requirements remains a significant challenge due to the complexity and variability involved.

In semiconductor manufacturing, processes such as RIE, ALE, PECVD, and ALD are commonly used. Each of these processes involves numerous parameters that need to be carefully selected and controlled to achieve the desired outcome. Traditionally, optimizing these parameters requires extensive experimentation and expert knowledge, making the process time-consuming and resource intensive.

Recent advancements in machine learning, particularly RL, offer promising solutions to these optimization challenges. RL algorithms can learn to make decisions by interacting with the environment, receiving feedback in the form of rewards or penalties, and optimizing their actions accordingly. Applying RL to process optimization in semiconductor manufacturing can potentially automate the development of process recipes, reduce the need for manual intervention, and significantly improve efficiency and precision.

This invention addresses the need for an autonomous system and method for generating process recipes using RL, applicable to a wide range of semiconductor process systems. By leveraging digital twins of the process system and incorporating various neural networks to simulate subsystem behaviors, this invention aims to optimize processes efficiently. The digital twins replicate the behavior of the real-world process system, allowing an RL agent to experiment and learn in a virtual environment. This approach reduces the time and cost associated with traditional trial-and-error methods in the real world and enhances the ability to achieve optimal process parameters at significantly lower cost.

To illustrate the application of this invention, the ALE process is used as an example. ALE is a process that alternates between surface modification and sputtering steps to achieve atomic-scale precision. Despite its advantages, optimizing the process parameters for ALE remains a challenge for process engineers. This invention's approach of using RL algorithms and digital twins can significantly streamline the optimization of ALE and other semiconductor processes. The inventive concept is generic and can be applied to various types of semiconductor process systems. By utilizing a system digital twin and an RL agent, the invention provides a novel and efficient way to autonomously generate process recipes, significantly advancing the state of the art in semiconductor manufacturing.

### SUMMARY

The present invention pertains to an advanced system and method for autonomously generating process recipes for semiconductor manufacturing. This innovative approach leverages RL and digital twins to optimize process parameters to achieve the best process performance. The invention particularly focuses on the use of a system digital twin and its neural network version to enhance computing efficiency, enabling the exploration of a large parameter space to identify optimized process recipes.

The system digital twin replicates the behavior of the real-world semiconductor process system, including but not limited to reactive ion etching (RIE), atomic layer etching (ALE), plasma-enhanced chemical vapor deposition (PECVD), and atomic layer deposition (ALD). By using neural network implementations of these digital twins, the system can perform rapid and efficient computations, which are crucial for real-time applications and extensive parameter space exploration.

At the core of this invention is the application of RL to autonomously generate process recipes. The RL agent uses a policy neural network and a Monte Carlo tree search (MCTS) program to determine the optimal actions to achieve desired outcomes through applying an RL algorithm. The policy neural network comprises an input layer that receives the current state of a substrate being processed and required output specifications, one or more hidden layers for processing, and an output layer. The output layer includes outputs that describe parameters for softmax/logistic functions. The output layer further includes a value predictor for the state. Each softmax/logistic function provides a probability distribution for a discretized process recipe parameter.

The MCTS program is integrated within the RL framework to manage the decision-making process. A node in this context represents the state of a substrate being processed. Each node can be expanded to multiple future nodes through actions defined by recipe parameters. Each action corresponds to one step or one cycle of the process, such as an ALE cycle, with selected process recipe parameters.

The RL agent continuously selects actions based on the outputs of the policy neural network and the MCTS program to form a network with many nodes. After reaching a terminal node, a virtual process case is completed, and criteria for calculating a reward are met. The terminal node satisfies certain process outcomes, such as a target etching depth. Each completed process with a chain of state-action pairs is considered a case. The RL agent explores in a large recipe parameter space to complete an episode consisting of many cases. Each state-action pair is associated with a reward by averaging the total received rewards involving the state-action pair divided by visit counts after the episode is completed. The value associated with a specific state or node is an average reward across all connected state-action pairs.

After the completion of an episode, the weights of the policy neural network can be updated to generate a new policy neural network that is more effective at high-reward actions. At the same time, the predicted value for a node can also be improved.

The RL agent continues to expand the network to generate more cases to improve the policy neural network until the changes in its weights are negligible. At this juncture, the policy neural network has been trained, and the output becomes deterministic. A process recipe can then be generated from the policy neural network for real-world applications.

In some embodiments, by using a computing-efficient system neural network for the system digital twin, the invention allows for the exploration of optimized process recipes across a vast parameter space. This capability significantly enhances the precision and efficiency of semiconductor manufacturing processes, reducing the time and cost associated with traditional trial-and-error methods and manual intervention.

In summary, the invention provides a robust and autonomous solution for optimizing semiconductor process recipes, leveraging advanced machine learning techniques and virtual simulations to achieve superior results in semiconductor fabrication.

### BRIEF DESCRIPTION OF THE DRAWINGS

The following brief descriptions relate to the accompanying drawings, which serve to enhance the clarity and understanding of the present disclosure:

FIG. 1: Illustrates a diagram of an exemplary process system.

FIG. 2: Depicts a functional diagram of a system controller configured to autonomously generate a process recipe using an RL agent.

FIG. 3: Presents a schematic representation of a system digital twin.

FIG. 4: Portrays a neural network representation for the system digital twin.

FIG. 5: Displays a process flow example using ALE, mapped for the RL processes.

FIG. 6: Shows a schematic representation of a policy neural network, integral to the RL process.

FIG. 7: Reveals a schematic diagram of an exemplary algorithm for RL, utilizing an MCTS program to autonomously generate a process recipe.

FIG. 8: Illustrates a flowchart describing the generation of a process recipe through RL.

Table 1: Outlines design parameters describing subsystem structures and topologies.

Table 2: Summarizes parameters that describe structures pre- and post-ALE processing.

Table 3: Showcases selected ALE process recipe parameters, discretized into levels suitable for implementing RL.

### DETAILED DESCRIPTIONS

This section delves into the specific embodiments of the present invention, aiming to provide a comprehensive understanding. It is important to note that while certain implementations are described to illustrate the inventive aspects clearly, any alterations and modifications that fall within the scope of the appended claims are intended to be encompassed by this disclosure. These detailed descriptions underscore the innovative features of the invention, setting it apart from existing technologies.

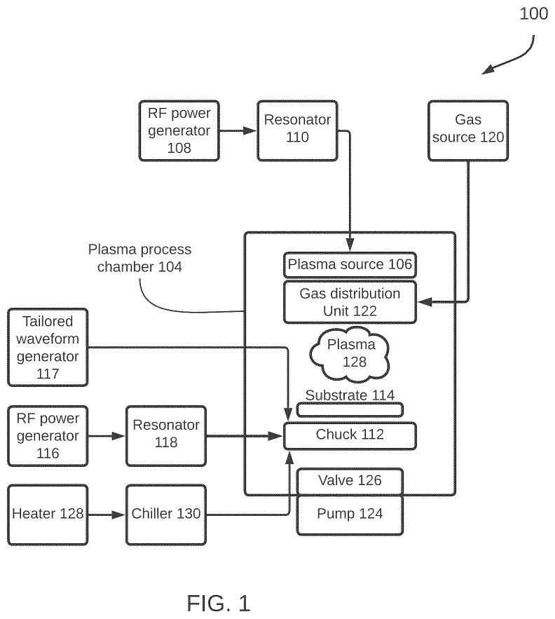

FIG. 1 illustrates an embodiment of a process system, designated as 100. The process system is generic for plasma-enhanced etching or deposition processes. For example, the process system 100 can be employed for reactive ion etching (RIE) or atomic layer etching (ALE). It can also be utilized for plasma-enhanced chemical vapor deposition (PECVD) or atomic layer deposition (ALD). In some cases, subsystems related to plasma generation may be removed, converting the process system 100 into a thermal process system. The inventive concept presented herein is generic and can be applied to any type of semiconductor process system. The plasma-based process system with a vacuum chamber is used for illustration only and should not limit the scope of the inventive concept.

The process system 100 includes a plasma process chamber 104, constructed to maintain a vacuum suitable for plasma processing. Within this system, a plasma source 106 is situated to receive radio frequency (RF) power from an RF power generator 108 via a resonator 110. The plasma source 106 may be realized in various configurations, such as an inductively coupled plasma (ICP) source or a transformer coupled plasma (TCP) source, among others.

The RF power generator 108 can operate at single or multiple frequencies—for instance, 13.56 MHz, 2.0 MHz, and 40 MHz may be used. The role of the resonator 110 is to match the output impedance of the RF power generator 108 with the impedance of the plasma process chamber 104, considering the impedance characteristics of the transmission lines. This resonator 110 typically comprises inductors and capacitors and may include mechanically adjustable capacitors. Alternatively, in other embodiments, the resonator 110 might exclude mechanically adjustable capacitors.

Impedance adjustments may be realized by varying the operating frequencies of both the RF power generator 108 and the resonator 110. During a process, the plasma is likely to exhibit variable states, which present different impedance levels. To maintain efficient energy transfer and minimize power reflection from the plasma process chamber 104 back to the resonator 110, it may be necessary to fine-tune the frequency for each distinct state of the plasma to ensure the resonator 110 remains in a resonating condition.

The plasma process chamber 104 is further outfitted with a chuck 112 that supports a substrate 114. The chuck 112 can be designed as an electrostatic chuck (ESC) or a vacuum chuck, depending on the process requirements. When an ESC is utilized, the chuck 112 is electrically connected to an RF power generator 116 via a resonator 118. Like resonator 110, resonator 118 requires tuning to a resonating state by adjusting its operating frequency. The operating frequencies of RF power generator 116 may differ from those of RF power generator 108. For instance, generator 116 may operate at a substantially lower frequency than generator 108.

The RF power generator 116 provides a bias to the chuck 112. This bias is delivered through a blocking capacitor, which, while not depicted, is standard in the field. Alternatively, a tailored waveform generator 117 may be employed to supply a bias to the chuck 112. The tailored waveform can significantly narrow the distribution of ion energies produced by the ignition of plasma 128 within the process chamber 104. Depending on the implementation, the tailored waveform generator 117 may be connected to the chuck 112 alone or in conjunction with the RF power generator 116 and resonator 118 to provide the required bias.

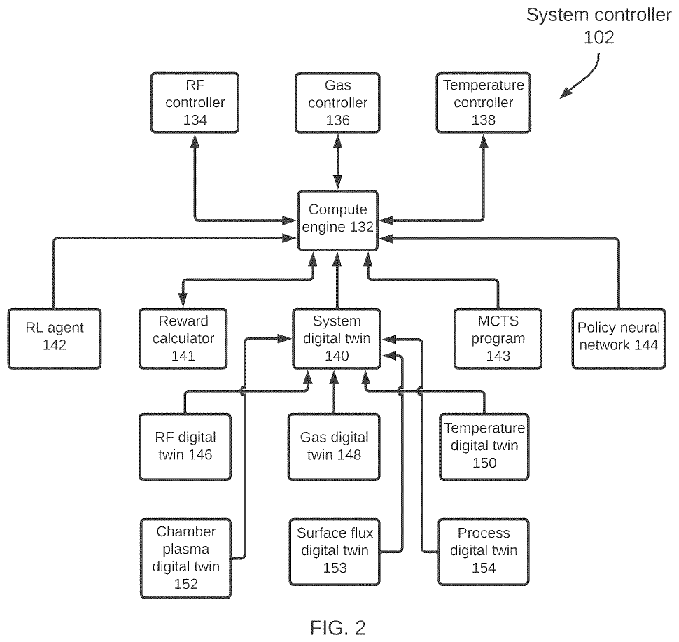

The operation of the RF subsystem, including the RF power generators, resonators, and plasma source, is managed by an RF controller 134 (FIG. 2). This controller communicates with and is subordinate to a compute engine 132 (FIG. 2).

The plasma process chamber 104 incorporates a gas distribution unit 122, tasked with delivering process gases from a gas source 120 into the chamber. The gas distribution unit 122 can take various forms, such as a gas injector or a showerhead, and may include a side injection feature near the inner surfaces of the chamber body. The gas source 120 typically draws from a facility's gas supply through a gasbox and uses a combination of valves, pressure regulators, and mass flow controllers (MFCs) to regulate the gas flow into the chamber. In some other implementations, precursor delivery systems for delivering a precursor in gas, liquid, or even in solid state may also be employed (not shown in the figure).

Additionally, the plasma process chamber 104 houses a pump 124, which may be a turbomolecular pump or another suitable type, designed to evacuate gases and by-products from the chamber. A valve 126, generally positioned atop the pump 124, modulates the evacuation rate from the chamber. The chamber pressure is monitored by a manometer (not illustrated), which triggers adjustments to the set point of an actuator of the valve 126 to maintain a constant pressure suitable for the ALE process.

The gas distribution subsystem, which includes the gas distribution unit 122, gas source 120, pump 124, and valve 126, is overseen by a gas controller 136. This controller is connected to the compute engine 132, ensuring integrated management of the process system 100.

The plasma process chamber 104 is also equipped with a temperature control subsystem to maintain the desired thermal conditions for the substrate and the chamber. In the embodiment exemplified in FIG. 1, the temperature of the chuck 112 is regulated by a temperature controller 138, which operates a heater 128 and a chiller 130, as well as a temperature sensor (not depicted). The chuck 112 may be designed with multiple zones, each maintained at a distinct temperature. Additionally, temperature control for other components within the process chamber, such as the gas distribution unit 122 and various chamber surfaces, may be required and is implemented as is common in the industry. The temperature subsystem is controlled by a temperature controller 138 coupled to the compute engine 132.

FIG. 2 showcases an embodiment of a system controller, denoted as 102, which enables autonomous operations due to its advanced capabilities. The system controller 102 includes a compute engine 132, integrated with the RF controller 134, the gas controller 136, and the temperature controller 138, ensuring cohesive operation of these subsystems. A distinct feature of this embodiment is the incorporation of a system digital twin 140 into the system controller, which effectively replicates the behavior of the process system 100 virtually. This feature positions the compute engine 132 as an intermediary between the real-world process system and its virtual counterpart.

Within the system digital twin 140, there are additional components: the RF digital twin 146, the gas digital twin 148, and the temperature digital twin 150, each simulating their respective subsystem operations. The system digital twin 140 further includes a chamber plasma digital twin 152 for simulating plasma generated in the chamber 104 based on the subsystem digital twin. A surface flux digital twin 153 generates electron, neutral, and ion fluxes at the surface of the substrate. A process digital twin 154 takes the fluxes as its input, simulates plasma-based processing on the substrate, and generates structure progression of the substrate as its output.

The system controller 102 further includes an RL agent 142 for managing the learning process using a policy neural network 144. The policy neural network 144 determines the probability distribution of selected process recipe parameters and predicts the value of the state based on the policy neural network. An MCTS program, denoted as 143, is subsequently applied to determine the parameters for a specific test. The RL agent continuously selects actions, defined by the determined parameters, based on the outputs of the policy neural network and the MCTS program until a terminal node, at which the criteria for calculating a reward are met. The reward is calculated after achieving specific process outcomes, such as a targeted etching depth. After a chain of actions is executed virtually through a process recipe, a reward is calculated by a reward calculator 141 and is assigned to state-action pairs involved in the test. Each completed virtual process with a reward is considered as a case. The RL agent 142 explores a parameter space through establishing a network formed by nodes. Each node is associated with a state describing a structure being processed. After an episode is completed through testing of enough cases, each state-action pair yields an average reward based on the total received rewards divided by the visit counts belonging to the state-action pair. The value for a specific state can then be computed by averaging the reward across all state-action pairs originating from the state.

The weights of policy neural network 144 are subsequently updated by leveraging the state-action pairs and associated values to make it more effective at generating actions from the state with higher rewards. These updated weights also improve the prediction of the value. Algorithms like stochastic gradient descent (SGD) can be employed to complete the training of the policy neural network. More than one episode may be required to generate sufficient synthetic data before the policy neural network 144 becomes deterministic for the final process recipe generation.

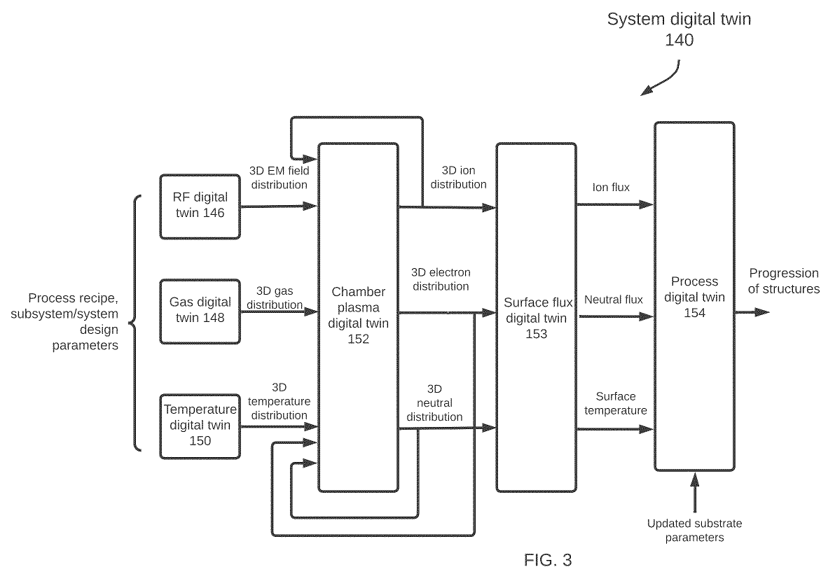

FIG. 3 illustrates schematically a flow of the system digital twin 140. The RF digital twin 146, the gas digital twin 148, and the temperature digital twin 150 take related process recipe parameters and subsystem and system design parameters as their inputs. This section provides a detailed discussion about the operations of the system digital twin 140.

The RF digital twin 146 is designed to simulate the RF subsystem, which includes at least RF power generators and resonators. In some cases, it may also include a tailored waveform generator for the bias, although the tailored waveform generator is typically not operated in the RF range. In one implementation, the RF digital twin 146 includes a SPICE model for the RF circuits, which determines the RF power deposited into the plasma source at a specific step. A Maxwell's equation solver is subsequently employed to compute the electromagnetic (EM) field distribution inside the chamber, considering the chamber structure parameters.

The RF digital twin 146 receives recipe parameters like RF power and initial operating frequency for a specific step stipulated by the process recipe. A set of system and subsystem design parameters, such as RF circuit topology, values of each component, structures, and parameters of the plasma source, and chamber structure parameters, are typically stored in a storage medium of the compute engine 132. A set of exemplary design parameters for the RF subsystem is listed in Table 1. The RF digital twin 146 can be used to determine resonating frequencies of the RF subsystems.

Similarly, the gas digital twin 148 replicates the functions of the gas distribution subsystem, encompassing elements like the gas source 120, the gas distribution unit 122, the pump 124, the valve 126, and the manometer (not pictured).

The gas digital twin 148 receives process recipe parameters like the flow rates of process gases. For example, for an ALE process, the gas digital twin 148 receives the flow rate for the first and second process gases and the chamber pressures for the surface modification step and the sputtering step, respectively. The design parameters for the gas delivery systems include the design parameters for the gas distribution unit as listed exemplarily in Table 1. If it is a showerhead, the design parameters will include its size, volume, distribution of injection channels/holes, and their sizes. The shape and size of the plasma process chamber are also important input parameters for the gas digital twin 148. The output of the gas digital twin 148 includes 3D gas distribution (e.g., density, partial pressure, velocity, and residence time) inside the gas distribution unit 122 and in the plasma process chamber 104. In some implementations, the gas distribution along gas lines from the gas source 120 to the entry of the gas distribution unit 122 will also be modeled. The gas distribution can be simulated using methods based on the fluid dynamics by leveraging finite element techniques, or other advanced computational techniques.

The temperature digital twin 150 mirrors the temperature control subsystem, which includes the heater 128, the chiller 130, and temperature sensors (not pictured). Besides the chuck temperature controls, it may additionally incorporate temperature regulation for other chamber parts such as the gas distribution unit 122.

The temperature digital twin 150 receives process recipe parameters like chuck temperatures at different steps. In some instances, the chuck 112 may be divided into zones, each with a different temperature specified by a process recipe. The input parameters to the temperature digital twin 150 further include design parameters for the heater and chiller as shown exemplarily in Table 1. For the heater 128, the design parameters include its locations inside the chuck or other chamber parts, as well as a range of its operating power. The design parameters for structures include thermal conductivity for various materials and their interfaces. For the chiller, the design parameters may include the type of coolants, flow rates of the coolants, and the number and locations of conduction channels. The temperature digital twin may apply numerical simulation methods like the finite element method to simulate the temperature distribution of the chuck, substrate surface, and inner surface of the plasma process chambers.

It should be noted that treating the digital twins 146, 148, and 150 independently may oversimplify the real world. For example, the RF power deposited into the chamber may affect the temperature of the substrate surface. Some of these interactions among different subsystem digital twins should be considered carefully.

The subsystem digital twins listed herein are exemplary only. In some process systems, digital twins for modeling interior chamber surface aging are also important for predicting accurately structure progression undergoing a process. In some other cases, erosion of edge rings along the edge of an ESC can also be an important factor which requires a different digital twin to improve the accuracy of the prediction. Therefore, the subsystem digital twins listed herein are elaborative but are not exclusive.

The outputs of the subsystem digital twins feed into the chamber plasma digital twin 152. At a specific time of a process step, the chamber plasma digital twin 152 models the plasma inside the chamber 104 and outputs 3D distributions of electrons, ions, and neutrals. The distributions at a specific time are a function of the EM field, gas, and temperature at that moment, as well as the distributions of electrons, ions, and neutrals prior to that moment. Therefore, the distributions of the electrons, ions, and neutrals need to be determined in a recurring manner. As shown in FIG. 3, the outputs of the chamber plasma digital twin can serve as inputs for the same digital twin for the next step. Each simulation event is for a predetermined step defined by the compute engine 132 based on the process recipe.

After the 3D distributions of ions and neutrals are known, the surface flux digital twin 153 calculates and outputs the ion flux and neutral flux toward the surface of the substrate. Additionally, the digital twin 153 may output the surface temperature of the substrate by working together with the temperature digital twin 150. The plasma sheath above the substrate is critically important for determining the ion flux, which greatly impacts the etching behavior. The formation of the plasma sheath is well understood in the art and can be modeled accurately using the chamber plasma digital twin 152.

The outputs of the surface flux digital twin 153 feed into the process digital twin 154 to simulate the process in the plasma process chamber 104. The status of the substrate structures serves as the inputs to the process digital twin 154. The updated substrate parameters are used by the process digital twin to determine its outputs.

The flow depicted in FIG. 3 represents a snapshot of the process during the step in the plasma process chamber 104. Therefore, the output of the process digital twin is a progression of the structures during the step.

During each step, the accumulated ion and neutral fluxes should be counted. Details of ion and neutral distribution are important for the process in the plasma process chamber. For ions, their energy and angular distributions during the step are critically important and can vary based on location on the surface of the substrate. The outputs of the surface flux digital twin 153 should include such critical details. Similarly, for neutrals, the density, thermal energy, and activation energy are important parameters for the substrate surface undergoing the process.

It should be noted that the designs of the subsystem, chamber plasma, and the process digital twins are exemplary herein. There could be many variations in implementation strategies. In some implementations, the chamber plasma digital twin and the surface flux digital twin could be combined into a single digital twin. In other implementations, the surface flux digital twin may be combined with the process digital twin. Additionally, the RF subsystem digital twin may be broken down into several digital twins to represent the plasma source and the bias units separately. Similarly, the temperature digital twin can be divided into two digital twins, with dedicated digital twins for the chuck and the gas distribution unit, respectively. All such variations are obvious and should fall within the inventive concept of the present inventions. Implementations of the digital twins by neural networks can follow the same strategy of dividing the process system into subsystems.

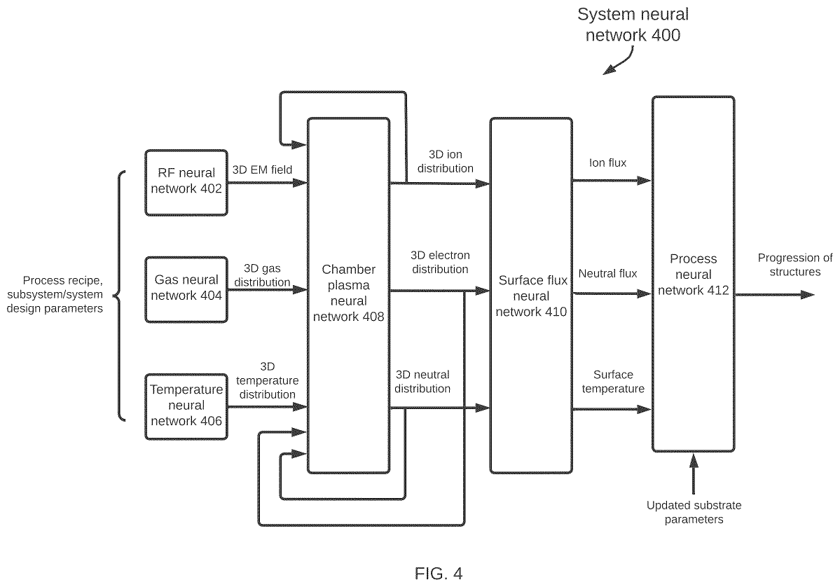

FIG. 4 illustrates an exemplary process system represented as a system neural network 400. In this embodiment, the subsystem digital twins are reconstructed using various neural networks. The RF digital twin 146 serves as the basis for training the RF neural network 402. Using the plasma source 106 attached to the RF power generator 108 and the resonator 110 as an example, one can begin by constructing a SPICE model to simulate the RF power generator 108 and resonator 110, including their transmission lines. The SPICE model outputs an initial AC current and voltage for the coils of the plasma source 106, necessitating an assumed initial impedance for the plasma 128. Following this, a numerical simulator applies Maxwell's equations to predict the EM field distribution within the plasma process chamber 104.

The wealth of simulation data generated by the RF digital twin 146 becomes the training set for the RF neural network 402. The inputs for the neural network 402 include RF circuit topology and parameters such as the values of the inductors, capacitors, resistors, and transistors within the generator and resonator, along with detailed modeling of effects and transmission lines. Additional parameters that characterize the plasma source, like its size, position, resistivity, inductance, and the number of coil-urns, are also incorporated.

Furthermore, the RF neural network 402 considers the chamber structure parameters—dimensional specifics, positions of the chuck and the gas distribution unit, and material properties of these components, as listed exemplarily in Table 1. Some parameters are measurable and thus provide a more substantial weight during the training of the RF neural network 402. For instance, sensors might track the current and voltage alterations in the coils or the reflected power at the resonator's output node 110. A B-dot sensor with multiple small coils could be positioned within the chamber to map the magnetic field distribution. The information gleaned from these sensors not only informs the training process but ensures that the RF neural network 402 is closely aligned with the real-world behaviors observed.

Utilizing a neural network for modeling the bias portion of the RF subsystem focuses on the electric field generated initially in response to the applied RF power. Unlike the magnetic field concerned with plasma generation, the bias deals with the electric field affecting the substrate surface.

Transitioning to the gas dynamics within the process system 100, we approach the gas distribution neural network 404, which is informed by the gas digital twin 148. Numerical algorithms based on the fluid dynamics are the foundation for determining the gas distribution within the chamber 104. This complex interplay involves the gas inflow from the gas distribution unit 122, the outflow managed by the pump 124 and the valve 126, which is influenced by the chamber's conductance and volumetric parameters. While numerical simulations offer accuracy, their demand for computational resources and time constraints necessitate a more efficient approach for real-time applications, hence the establishment of the gas distribution neural network 404.

The gas distribution neural network 404 is trained with simulation data reflecting various parameters, including the types and flow rates of gases, the design of the gas distribution unit 122, the pump's capacity 124, and the set point of the actuator of the valve 126, along with chamber dimensions and conductance. Some of the design parameters are listed in Table 1. The gas distribution unit 122 implemented as an injector, a showerhead, or a combination of both can affect the gas distribution in the process chamber 104. The size, quantity, and distribution of channels/holes inside the injector and the showerhead are important design parameters. Gas pressure within the process chamber, monitored by a manometer, provides measurement data that enhances the training of the gas distribution neural network 404, often weighted more significantly than the simulation data to ensure the model's relevance to actual conditions.

Parallel to these developments is the creation of the temperature control neural network 406, drawn from the temperature digital twin 150. This neural network is dedicated to mapping the thermal landscape within the plasma process chamber, particularly at the substrate surface. Its training originates from numerical models that simulate heat interactions and distributions. Inputs for the temperature neural network 406 include chuck and chamber parameters affecting thermal conduction. In scenarios involving an ESC, the thermal characteristics of the ESC and the heat conduction efficiency, potentially affected by helium pressure used as a medium, are critical. Additional chamber specifications, such as size and construction materials, also influence the model. Temperature readings from sensors within the chuck 112 and the chamber 104 provide valuable real-world data, which, when used to train the temperature neural network 406, carry heavier weights over simulated data due to their direct measurement of the physical environment. This balance of simulated and measured data ensures that the various neural networks closely mimic the actual processes, thereby enabling accurate predictions and controls within the ALE process system.

FIG. 4 elucidates the intricacies of the system neural network 400, where the outputs of the subsystem neural networks act as inputs to the chamber plasma neural network 408. The chamber plasma digital twin 152 serves as the foundation for the chamber plasma neural network 408, enabling a sophisticated representation of the plasma within the etching chamber.

To simulate the movement of particles within the plasma, either a Monte Carlo or a numeric plasma simulator can be used to visualize the three-dimensional distribution of electrons, ions, and neutrals. This is crucial because electrons, which are significantly lighter, move more rapidly than ions, leading to the creation of a sheath on the surfaces within the chamber. This sheath plays a pivotal role in ion acceleration toward the substrate, a process essential for sputtering but potentially counterproductive during surface modification.

The training of the chamber plasma neural network 408 integrates simulation data for faster computation and higher efficiency. However, to refine its predictive capabilities, it may also assimilate measurement data gathered from sensors within the chamber, such as optical sensors that detect light emission from neutrals and hairpin sensors that gauge electron density. This measurement data may be given a heavier weight over the simulated data to ensure that the outputs of the plasma neural network 408 are as realistic as possible.

The dynamic nature of the plasma environment is captured by the recurrent neural network (RNN) design of the chamber plasma neural network 408. This means it can process temporal sequences, taking snapshots of plasma conditions at a given time and incorporating them into the model for future predictions. It is an ongoing cycle where the neural network's previous outputs become part of the input data for the next time step, mimicking the continuous evolution of the plasma state.

Once the chamber plasma neural network 408 has computed the 3D distributions, the ion and neutral fluxes to the substrate surface can be determined based on a surface flux neural network 410. The ion and neutral fluxes, along with the surface temperature of the substrate, are then taken as inputs for the process neural network 412. The process neural network 412 can be trained based on the data generated by the process digital twin. The outputs of the process neural network 412 further include the progression of the structure parameters.

Ultimately, the chamber plasma neural network 408 and the surface flux neural network 410 yield valuable outputs beyond just fluxes; they also provide critical insights into the surface temperature by working together with the temperature neural network 406. The accumulated fluxes during the steps should also include valuable information about ion energy and angular distribution, as well as neutral thermal energy and activation energy. These parameters are essential for fine-tuning the process in the plasma chamber to achieve the desired etching precision and substrate surface quality.

It should be noted that FIG. 4 showcases an embodiment 400 of a full neural network implementation of the system digital twin 140. In other embodiments or implementations, some functional blocks may not be implemented as neural networks. For example, the surface flux neural network 410 may be an analytical model. Hence, embodiment 400 is exemplary. There may be many variants of implementations by combining models, lookup tables, analytical models, numerical models, and Monte Carlo models for selected building blocks of the system digital twin 140. All such variants fall within the scope of the present inventive concept.

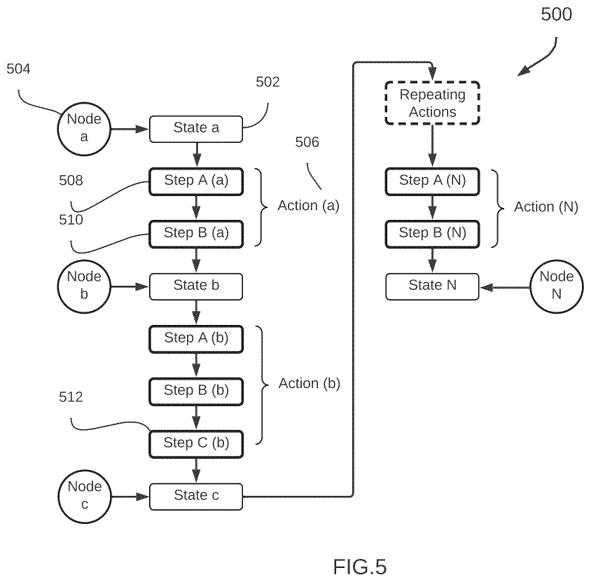

An ALE process is employed herein as an example to illustrate a system and method for autonomously generating a process recipe through the application of an RL algorithm. FIG. 5 illustrates an ALE process flow 500, which is suitable for implementing the RL algorithm. An exemplary ALE process typically involves alternating between a surface modification step A and a sputtering step B in a cyclic manner. It should be noted that steps A and B herein are commonly called half cycles of the ALE process, which are different from the steps we discussed previously for simulating plasma behavior in the chamber.

During step A, the surface of the substrate 114 is chemically altered using chemically active neutrals formed in the plasma, which is generated by a plasma source powered by an RF power generator. A halogen gas, such as chlorine, is often introduced to produce neutrals for this purpose. During this surface modification step, the bias to the chuck is typically set to zero to minimize the impact of ions on the substrate, thereby preserving the integrity of the ALE process.

Conversely, during the sputtering step B, an inert gas like argon is introduced to generate energetic ions that physically remove the chemically modified layer from the substrate by sputtering. At this juncture, a bias is typically applied to the chuck through the RF power generator and resonator.

Between these steps, a purge step may be employed to transition the gases from step A (508) to step B (510) or vice versa without intermixing the two process gases. The purge steps are not shown in FIG. 5. Step A (a) shown in FIG. 5 represents step A at the node a. Similarly, step B (a) represents step B at node (a).

In some instances, particularly when etching high aspect ratio structures, an additional deposition step C (512) can be optionally included along with steps A and B. This step C is strategically inserted into the ALE cycle sequence but at a less frequent rate compared to steps A and B. Its primary function is to protect the sidewalls of the etched structures, thus preventing lateral etching that may arise due to the angular distribution of ion momentum. Step C (b) represents step C at the node b.

An ALE process runs in cycles, with each cycle including a step A and a step B. As shown in FIG. 5, an ALE cycle starts from a state and completes in another state. A state is denoted as 502, which describes the substrate undergoing processing. State a represents the state at the node a. Specifically, in an ALE process, the state describes one or multiple structures. The description of the states includes, but is not limited to, parameters describing a structure being etched, such as depth, critical dimensions, profiles, and loadings as shown exemplarily in Table 2. The state 502 is associated with a node 504. Hence, state a is associated with the node a. The ALE cycle starts initially at a node with a state, executes an action, denoted as 506, by selecting process recipe parameters using a policy neural network and MCTS program, and completes at another node with an updated state. In FIG. 5, action (a) denotes the action triggered by the ALE recipe at the node a.

It should be noted that a node can lead to more than one node through different actions. If the recipe parameters are continuous, the available new nodes would be infinite. Conversely, if the recipe parameters are discretized to limited levels, the available new nodes will be limited.

An ALE cycle is used for an action in FIG. 5 as an example only. In some other implementations, a half cycle can be employed to separate the nodes. In such a case, the action is either a surface modification step A, a sputtering step B, or even a deposition step C. All such variations will fall within the scope of the present inventive concept.

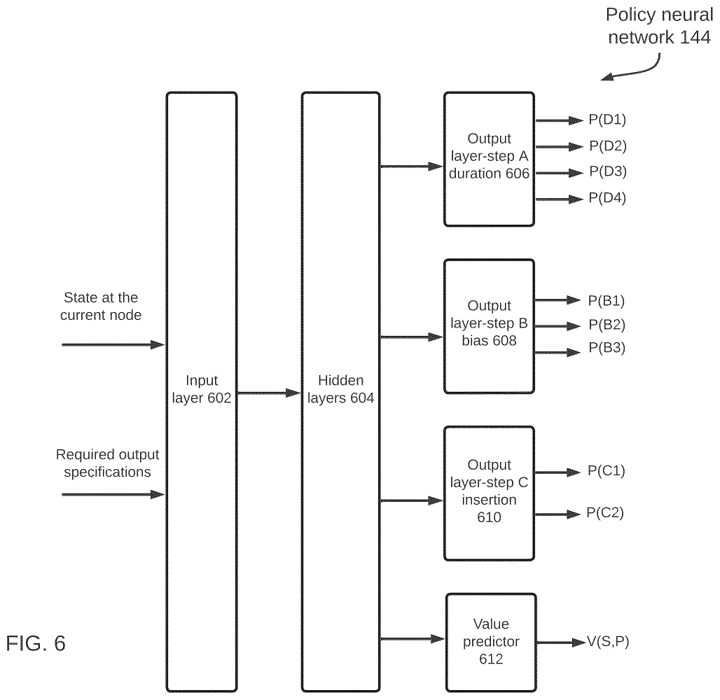

FIG. 6 showcases an exemplary policy neural network 144. The network 144 comprises an input layer 602 for receiving the state of the current node and required output specifications as its inputs. It should be noted that the output specifications here are final requirements after completion of the entire process, not a step of the process. Inclusion of the output specifications as one of the inputs of the policy neural network 144 makes it more generic and able to deal with changes in output specifications. In some other implementations, the inputs include only the state.

The policy neural network 144 further includes one or more hidden layers, denoted as 604, for processing received data from the input layer 602. The policy neural network 144 further comprises an output layer which may include multiple parts, each part further includes several parameters describing softmax or logistic functions. The parts of the output layer are depicted in FIG. 6 as 606, 608, and 610 exemplarily, each delivering a probability distribution of a discretized process recipe parameter with more than one level. Furthermore, the output layer includes a value predictor 612 for predicting the value of the state based on the current policy represented by the policy neural network 144 with the current weights.

FIG. 6 exemplifies the ALE process, wherein three recipe parameters are selected. The first part 606 delivers probability distributions of 4 levels of the duration of step A, denoted as D1, D2, D3, and D4, where P(D1), P(D2), P(D3), and P(D4) are the probabilities of each level, respectively. A softmax function can be utilized to describe such 4-level probability distribution with 4 output parameters of the part. The probability can then be calculated accordingly. Similarly, the second part 608 outputs probability distributions of 3 levels of the chuck bias of step B. The third part 610 delivers probability distributions of 2 possibilities for either including or excluding a step C after step B in the ALE cycle. The two-level probability distribution can be represented by a logistic function. Exemplary ALE recipe parameters for this implementation are depicted in Table 3. The exemplary input parameters are listed in Table 2.

It should be noted that different sets of ALE recipe parameters may be selected, and different levels may be selected for each parameter. If the process system 100 is employed for a different type of process like deposition, the parameter selection may be different. The example herein is for illustration purposes and should not be considered a limit for the inventive concept. Furthermore, the selection of the recipe parameters and levels may be dynamic. It means they may be modified during the execution of an RL algorithm. In one implementation, after a predetermined number of episodes are executed, the RL agent 142 may decide to narrow down the parameter space and adjust ranges and levels of the parameters to accelerate the convergence of the RL algorithm. In some implementations, old parameters may be removed, and new parameters may be added. In still some other implementations, the entire set of recipe parameters may be selected and determined through the execution of the RL algorithm. The ranges of the parameters are related to subsystem capability and capacity and are stored in the storage medium of the compute engine 132 of the system controller 102.

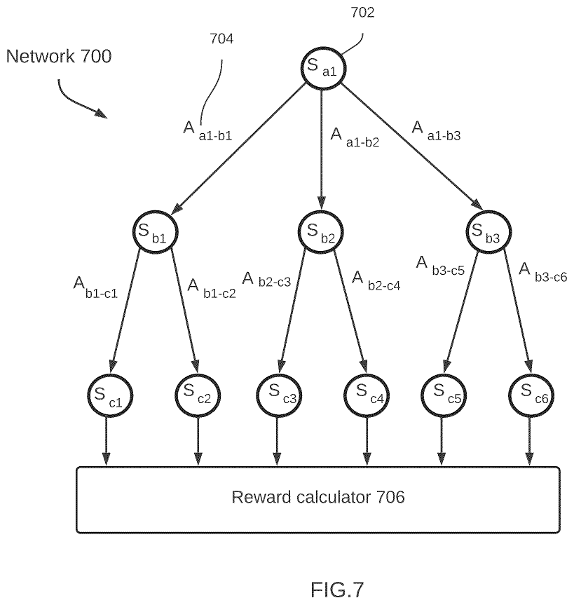

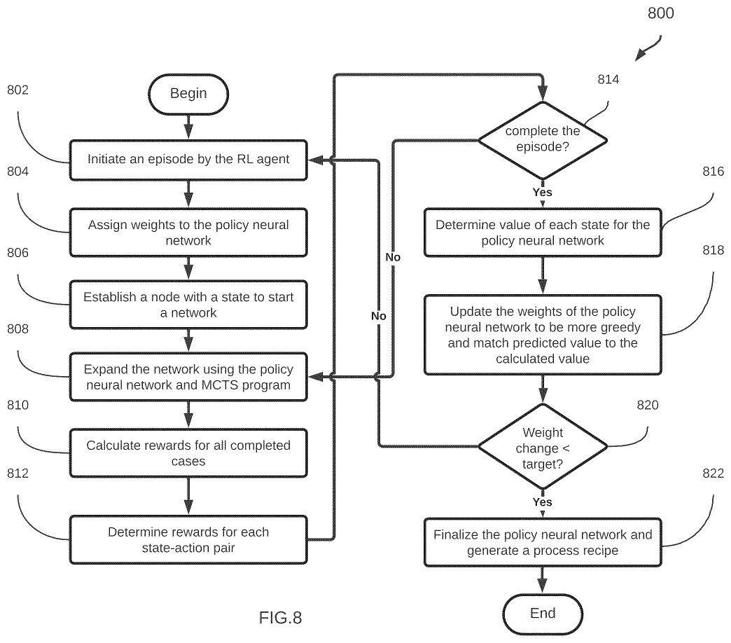

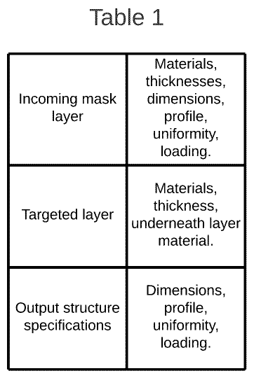

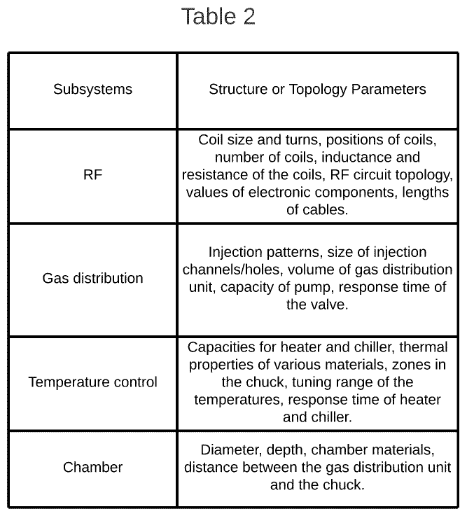

FIG. 7 schematically reveals a network 700 resulting from RL process being rolled out through the MCTS algorithm. As shown in FIG. 7, nodes like node 702 are represented by circles. Each node is associated with a state, such as Sₐ₁ in the cycle. A parent node can lead to multiple child nodes upon the execution of an action like 704. For example, the node with the state Sₐ₁ can transit into a node with the state S_{b1} resulting from the action A_{a1-b1}. The RL agent 142 manages the selection process through the policy neural network 144 and the MCTS program 143. For the ALE process, each action represents exemplarily one ALE cycle with selected process recipe parameters although a half cycle could also be an option. The selection of an action continues until reaching a terminal state where criteria are met to calculate a reward by a reward calculator 706. For example, in the case of an ALE process, the reward is calculated when a specific etching depth is reached.

A reward can be designed based on a cost function. A cost function for the ALE process is typically formulated as a square function pertaining to each output parameter of the structure post the ALE processing. The cost function can be defined as:

$$c = {\sum }_{i = 1}^{N} {{w}_{i} ( {p}_{i} - {p}_{itarget} )}^{2} , \qquad [ 1 ]$$

where c is the cost, wᵢ is the weight, and pᵢ is a normalized output parameter like critical dimension at a selected vertical coordinate, p_{itarget} is the normalized target value of the output parameter, and N is serial number of the parameter. If multiple structures are evaluated, the cost function can be further expressed as:

$$C = {\sum }_{j = 1}^{M} {W}_{j} {c}_{j} , \qquad [ 2 ]$$

where C is the accumulated cost across multiple structures, Wⱼ is the weight, and cⱼ is the cost for one structure. The method can take several or many structures across a substrate like a 300 mm wafer. The method can further take different structures or different parts of the structure to quantify various loading effects. A reward can be designed as:

$$R = f ( c ) , \qquad [ 3 ]$$

Where R is the reward, and ƒ is a function for determining the reward based on the cost c. In one implementation, the reward may be designed as multiple, or many discrete numbers based on the cost. For example, the range of the cost can be divided into 10 intervals. Each interval is represented by an integer.

Each time the RL process reaches the terminal node, the reward can be computed. Each state-action pair like (Sₐ₁, A_{a1-b1}), which is a part of state-action chain for the test case to receive the reward. A visit count for the pair will also be updated. After enough test cases are executed and an episode is completed, the average reward associated with each state-action pair can be calculated as the accumulated reward divided by the visit counts.

The value associated with a node can then be calculated by averaging the reward across all state-action pairs originating from the node. These data can be employed to train the policy neural network 144 to be greedier for generating actions with higher rewards.

In some implementations, the RL algorithm can be designed to be biased toward exploration than exploitation. For example, in a new episode for RL, the initial weights for the policy neural network can be assigned randomly. This can be a useful technique to prevent the RL process from being trapped in a local optimal point in the parameter space.

In some other implementations, the technique like ε-greedy algorithm may be employed to expand the search tree. The algorithm allocates a part of the probability distribution to a completely random distribution and is well known in the art.

The ALE example herein is for illustration only. For a real RL process, the number of nodes could be huge. The weights will be updated continuously to narrow down the selection of actions until the policy neural network 144 becomes deterministic. Subsequently, a process recipe can be generated for real-world applications.

The reward calculator 706 is typically implemented as software programs, managed by the RL agent 142.

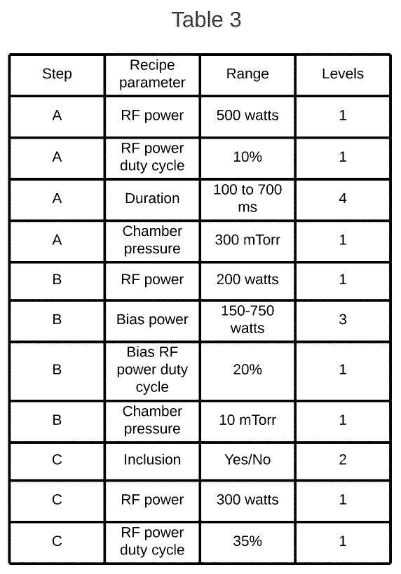

FIG. 8 showcases a flowchart for a process 800, which is a self-initiated process for autonomously generating a process recipe through an RL process. Process 800 starts with step 802, where the RL agent 142 initiates an episode for the RL process. An episode is represented by a network consisting of many nodes created by the MCTS program enabled by the policy neural network. Each episode comprises many cases, wherein each case represents a completed simulation for a virtual process based on the system digital twin. For example, a case for an ALE process yields a completed ALE process. The structures on the substrate have met a set of criteria, such as reaching targeted etching depth. This typically includes a chain of actions and multiple or many intermittent states. A completed episode should deliver the rewards associated with state-action pairs and the value of the nodes.

In step 804, initial weights are assigned to the policy neural network. In one implementation, the weights are assigned randomly. In another implementation, the weights are based on a previous RL episode, enabling continuous improvement which makes the policy neural network 144 generate more greedy actions to increase reward.

In step 808, an initial node for a network is established. The initial node is associated with an initial state which describes an incoming substrate with a set of parameters as listed exemplarily in Table 1. At this point in time, the RL agent 142 applies the policy neural network 144 to generate probability distributions of selected recipe parameters. Based on the probability distribution, the MCTS program 143 is employed to generate an action with determined recipe parameters. A random number generator is typically applied based on the distribution to generate the action. Subsequently, the RL agent 142 applies the action by leveraging the system digital twin 140 to generate the next node with a new state. The process repeats until a case is completed.

In step 808, the network is expanded progressively using the policy neural network 144 and the MCTS program 143. Each state-action pair of the network is associated with a visit count. Some state-action pairs are involved in more than one case, which is accounted for by the visit count.

In step 810, rewards are calculated based on the reward calculator 141 for all completed cases. If the state-action pair is involved in a specific case, it will receive the reward accordingly in step 812. The reward accumulates as the visit count is increased. The average reward for a specific state-action pair is the accumulated rewards divided by the visit count of the state-action pair.

In step 814, the RL agent 142 judges if the episode is completed. A decision may be made by evaluating nodes in the network and completed cases against selected recipe parameters/discrete levels. If the result is negative, the RL agent 142 continues to expand the network. Otherwise, the RL agent 142 determines the value for each state in step 816. For each node associated with the state, the RL agent 142 has established relationships between state-action pairs and their associated rewards. The value of the node based on the current policy neural network can be computed as an average of the reward across all the state-action pairs.

In step 818, the RL agent 142 updates the weights of the policy neural network 144 based on all available state-action pairs. At each node, the state is an input for the policy neural network 144, and a set of softmax/logistic function parameters are the outputs. The output also includes the predicted value. The updated weights should make the policy neural network greedier to generate actions with higher value and to predict the value more accurately. As the policy neural network 144 improves, it should become more deterministic to select an action from a group of available actions to generate the highest reward. This becomes a typical classification problem, hence a cost function for updating the policy neural network 144 should include a cross-entropy loss function and a square error for the value. The policy neural network 144 can be trained by leveraging rewards associated with all actions from the node. In one implementation, the earlier nodes may carry heavier weight during training to be consistent with a discount rule.

In step 820, the RL agent 142 evaluates if the weights are converged to give a deterministic policy neural network. If the result is negative, the RL agent 142 can initiate a new episode to repeat the process and generate more data through more exploration. In one implementation, an ε-greedy algorithm may be employed to encourage exploration against exploitation. In another implementation, a new set of initial weights for the policy neural network 144 may be applied. In yet another implementation, the weights generated from the previous episode may be used together with the ε-greedy algorithm.

If the evaluation in step 820 is positive, the policy neural network 144 is finalized in step 822. A process recipe can be generated accordingly. The generated recipe can then be deployed to substrate processing in a real-world process system.

1. A system controller for a semiconductor process system, comprising:
a plurality of subsystem controllers for controlling operations of subsystems, wherein the subsystems are modeled by subsystem digital twins;
a system digital twin including at least the subsystem digital twins for simulating a substrate progression in a vacuum process chamber;
a policy neural network designed to enable a self-initiated reinforcement learning (RL) process; and
an agent for autonomously generating a process recipe through executing the self-initiated RL process by utilizing the policy neural network and the system digital twin.

2. The system controller of claim 1, wherein the policy neural network further includes an input layer, a plurality of hidden layers, and an output layer, wherein the output layer further includes outputs describing softmax and/or logistic functions for probability distributions of selected process recipe parameters across a plurality of discretized levels.

3. The system controller of claim 2, wherein the self-initiated RL process further includes a Monte Carlo tree search (MCTS) program, which generates selected recipe parameters based on the probability distributions.

4. The system controller of claim 3, wherein the policy neural network further includes a state of the substrate and required output specifications as its inputs, wherein the state of the substrate is further described by a plurality of parameters and is associated with a node in a network, wherein the network is a representation of a plurality of state-action pairs.

5. The system controller of claim 4, wherein a process recipe with generated recipe parameters defines an action, wherein the system controller executes the action virtually based upon the system digital twin to bring the substrate from a current state into a new state associated with a new node.

6. The system controller of claim 5, wherein the policy neural network further includes a value predictor for a state.

7. The system controller of claim 1, wherein the system digital twin further includes one or a plurality of neural networks.

8. The system controller of claim 7, wherein the neural networks are trained by synthetic data generated from the system digital twin, wherein the training can be enhanced by measured data through various sensors associated with the process system.

9. The system controller of claim 1, wherein the subsystems further include an RF subsystem, a gas distribution subsystem, and a temperature control subsystem.

10. The system controller of claim 1, wherein the system controller can be deployed for an etching or a deposition process system.

11. A method for processing a substrate by employing a process system, comprising:
initiating by a reinforcement learning (RL) agent of a system controller an episode for establishing a process recipe for the process system through an RL process, wherein the episode further includes a plurality of simulated process cases by leveraging a process system digital twin;
assigning by the RL agent weights to a policy neural network, wherein the policy neural network further includes an input layer, a plurality of hidden layers, and an output layer, wherein the output layer further includes outputs describing softmax or logistic functions for generating probability distributions of two or more discretized levels of selected process recipe parameters;
establishing by the RL agent a node associated with a state and expanding the node into a network including a plurality of nodes consisting of a plurality of state-action pairs, wherein the RL agent employs the policy neural network and a MCTS program to form the state-action pairs, wherein the state describes the substrate being processed virtually;
calculating by the RL agent a reward for each case, wherein the case further includes a chain of state-actions, wherein the last state is a terminal state which meets criteria for the reward calculation;
determining by the RL agent a reward for each state-action pair;
determining value for each state after the episode is completed;
updating the weights for the policy neural network by leveraging determined rewards for the state-action pairs and the value for the states, whereby the updated policy neural network becomes greedier for generating actions with higher value;
finalizing the process recipe by utilizing the policy neural network after the RL process has converged; and
applying the generated process recipe for real-world applications.

12. The method of claim 11, wherein the policy neural network further includes a value predictor as an output.

13. The method of claim 12, wherein the updated weights further improve prediction of the value.

14. The method of claim 11, wherein one or more than one episode may be required to get the RL process converged.

15. The method of claim 11, wherein the RL agent further applies strategies to encourage exploration in a parameter space, wherein the strategies further include an &-greedy algorithm.

16. The method of claim 11, wherein the process system digital twin further includes neural networks.

17. An atomic layer etching (ALE) process system, comprising:
a vacuum process chamber;
a plurality of subsystems controlled by a plurality of subsystem controllers; and
a system controller further includes:
a plurality of subsystem digital twins for simulating operations of the plurality of subsystems;
a system digital twin including at least the plurality of subsystem digital twins for simulating an ALE process in the vacuum process chamber, wherein the ALE process further includes a surface modification step and a sputtering step;
a policy neural network designed to enable a self-initiated reinforcement learning (RL) process; and
an agent for autonomously generating a process recipe through the self-initiated RL process by utilizing the policy neural network, wherein the system digital twin is employed to simulate transition of a substrate from one state to another state, wherein the state is represented by a plurality of parameters describing a substrate being processed virtually.

18. The ALE process system of claim 17, wherein the RL algorithm further includes a Monte Carlo tree search (MCTS) program.

19. The ALE process system of claim 17, wherein the policy neural network further includes an input layer with a plurality of inputs, a plurality of hidden layers, and an output layer with a plurality of outputs, wherein the inputs further comprise at least a state of the substrate, wherein the outputs further include probability distributions of selected process recipe parameters.

20. The ALE process system of claim 19, wherein the selected recipe parameters further include a duration of the surface modification step and a bias of a chuck during the sputtering step.
